(19) United States
(12) Patent Application Publication
(10) Pub. No.: US 2022/0232569 A1
(43) Pub. Date: Jul. 21, 2022

(54) LOW LATENCY COMMUNICATION DEVICES AND METHODS FOR THE LICENSED AND UNLICENSED SPECTRUM

(71) Applicant: Telefonaktiebolaget LM Ericsson (publ), Stockholm (SE)

(72) Inventors: Bikramjit Singh, Kirkkonummi (FI); Kittipong Kittichokechai, Järfälla (SE); Alexey Shapin, Luleå (SE)

(21) Appl. No.: 17/614,769

(22) PCT Filed: May 27, 2020
(86) PCT No.: PCT/SE2020/050537

§ 371 Date: Nov. 29, 2021

(30) Foreign Application Priority Data
May 27, 2019 (SE) 1950628-6

(51) Int. Cl. H04W 72/04; H04L 1/18; H04W 74/08; H04W 72/14

(52) U.S. Cl. CPC H04W 72/0453; H04W 72/14; H04W 74/0808; H04L 1/1812

(57) ABSTRACT

A method for a user equipment (UE) is provided. The method is performed by the UE in Ultra-Reliable and Low-Latency Communications, URLLC. The method includes receiving, from a first network node, a first transport block on a first carrier. The method further includes receiving, from a second network node, a second transport block on a second carrier. Furthermore, the method includes receiving information that joint processing of the first transport block and the second transport block is enabled, where the first transport block and the second transport block include the same data. Further, methods performed by a network node and are also provided. Furthermore, a UE, network nodes, computer programs and carriers are also provided.

### TECHNICAL FIELD

Embodiments herein relate generally to a User Equipment (UE), a method performed by the UE, a network node and a methods performed by the first network node and more particularly to the use of these devices and methods for low latency communication in the licensed and unlicensed spectrum.

### BACKGROUND

The embodiments herein are directed to Ultra-Reliable and Low Latency Communications (URLLC) traffic in a New Radio (NR) Licensed and Unlicensed (NR-U) communications network. NR-U is being considered in 3GPP to bring NR to the unlicensed wireless communication bands, i.e., unlicensed spectrum. NR may expand into the unlicensed 5 GHz and 6 GHz bands. NR-U comprise two modes of operation: non-standalone wherein operators can aggregate the unlicensed bands with licensed 5G frequencies to bolster capacity similar to Licensed-assisted access (LAA), and standalone wherein an enterprise could use unlicensed spectrum to deploy a private cellular network.

Further, URLLC data, for example, is characterized by requirements for very low packet error rate and minimal over-the-air latency. Low latency allows a network to be optimized for processing incredibly large amounts of data with minimal delay. The networks need to adapt to a broad amount of changing data in real time. 5G will enable this service to function. URLLC is, arguably, the most promising addition to upcoming 5G capabilities, but it will also be the hardest to secure; URLLC requires a quality of service (QoS) totally different from mobile broadband services. Low latency is important for use cases such self-driving cars or remote surgeries.

Rel-15 supports configured grant (CG) in addition to dynamic grant for uplink (UL) URLLC services in NR spectrum. In CG, a user equipment (UE) is allocated recurring resource for its recurring traffic, so that UE need not to ask for a scheduling request (SR) before every packet transmission. Now each recurring resource may compose of multiple K Transmission Opportunities (TOs) for the transmission of K repetitions (same or different RVs). Further, CG classified as Type 1 and 2 depending on the activation ways. As the spectrum is reliable (not unlicensed), here network node doesn't transmit ACK for UE's transmission success. The network node may be for example a gNB.

Numerous studies are on-going to investigate the potential of free or unlicensed or shared spectrum. Such spectrum is likely to be shared, hence it offers lower transmission reliability in comparison to licensed or dedicated spectrum. 3GPP is developing solutions in which cellular services may be catered on unlicensed spectrum. For example, if a UE intends to use unlicensed spectrum, it may employ Clear Channel Assessment (CCA) schemes to determine whether the channel is free during a certain period such as the Channel Occupancy Time (CoT). In NR-U, channel access in both downlink and uplink rely on the listen-before-talk (LBT) for channel assessment.

The NR spectrum offers reliable services, but a possible disadvantage of the NR spectrum is that could be expensive and scarce. The NR-U spectrum is less reliable but is often a more cost effective alternative. In some implementations NR-U may even be a spectrum that comes at no cost.

NR is currently being standardized to deliver URLLC services with high reliability and low latency. One feature of UL URLLC is CG. NR-U is a free/inexpensive spectrum in the form of unlicensed or shared spectrum it may however be less reliable that for example the licensed spectrum. NR-U is also currently being developed to deliver cellular services on unlicensed part. However, the reliability requirements for NR-U are not as strict as for URLLC services in NR, and also NR-U is being built as a standalone entity. Therefore, the problem is the lack of collaboration between NR and NR-U in supporting URLLC services in a unified manner.

When UE is configured to receive NR licensed and NR unlicensed carriers at the same time, currently cross carrier scheduling is done in the way that transport blocks for each carrier are different. Such algorithm of operation is optimal for broadband traffic, however, for critical traffic such as URLLC it is beneficial to duplicate data for reliability or schedule data transmissions and retransmissions across different carriers if at one carrier there is not enough resources. Currently the duplication can be done by higher layers (PDCP duplication). However, the simple duplication can lead to inefficient usage of radio resources.

Therefore, there is a need to at least mitigate or solve these issues.

### SUMMARY

An objective of embodiments herein is therefore to obviate at least one of the above disadvantages and to provide an improved communications system.

Embodiments herein afford many advantages, of which a non-exhaustive list of examples follows:

In one embodiment a method for a user equipment, UE, is provided. The method is performed by the UE in Ultra-Reliable and Low-Latency Communications, URLLC. The method includes receiving, from a first network node, a first transport block on a first carrier. The method further includes receiving, from a second network node, a second transport block on a second carrier. Furthermore, the method includes receiving information that joint processing of the first transport block and the second transport block is enabled, where the first transport block and the second transport block include the same data.

Corresponding embodiments of inventive concepts for a UE, a computer program, and a carrier are also provided.

In another embodiment, a method for a network node is provided. The method performed by the network node in URLLC. The method includes transmitting, to a user equipment, UE, a first transport block on a first carrier. The method further includes transmitting information, to the UE, that joint processing of the first transport block and a second transport block, transmitted to the UE on a second carrier, is enabled, where the first transport block and the second transport block include the same data.

Corresponding embodiments of inventive concepts for a network node, a computer program, and a carrier are also provided.

In yet another embodiment there is provided a method for a network node. The method is performed by a network. The method includes performing channel assessment for unlicensed spectrum and if clear channel is available in the unlicensed spectrum allocating a resource in the unlicensed spectrum until the assessment procedure is scheduled. If clear channel is not available, the method includes allocating a resource in the licensed spectrum until the assessment procedure is scheduled.

Corresponding embodiments of inventive concepts for a network node, a computer program, and a carrier are also provided.

One advantage of the embodiments herein is that the use of unlicensed spectrum in supporting URLLC services together with NR licensed spectrum may help to improve system spectral efficiency, reduce latency, enhance reliability, and/or downsize spectrum related cost.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail by way of example only in the following detailed description by reference to the appended drawings illustrating the embodiments and in which:

FIG. 1 is a schematic drawing illustrating a communications system.

FIG. 2 illustrates a joint cross carrier physical layer processing of one transport block.

FIG. 3 illustrates that a resource is allocated either in unlicensed spectrum (if CCA successful in unlicensed part), or licensed spectrum (if CCA failed in unlicensed part).

FIG. 4 illustrates that TOs are distributed over licensed and unlicensed spectrum.

FIG. 5 illustrates that a UE transmits SR for the transmission in dedicate resource in case CCA fails for unlicensed part.

FIG. 6 is a flowchart depicting a method in a wireless device, according to embodiments herein.

FIG. 7 is a flowchart depicting a method in a network node, according to embodiments herein.

FIG. 8 is a flowchart depicting a method in a network node, according to embodiments herein.

FIG. 9a is a schematic drawing illustrating an example of a UE.

FIG. 9b is a schematic drawing illustrating an example of a UE.

FIG. 10a is a schematic drawing illustrating an example of a network node.

FIG. 10b is a schematic drawing illustrating an example of a network node.

FIG. 11 is a schematic block diagram illustrating a telecommunication network connected via an intermediate network to a host computer.

FIG. 12 is a schematic block diagram of a host computer communicating via a base station with a user equipment over a partially wireless connection.

FIG. 13 is a flowchart depicting embodiments of a method in a communications system including a host computer, a base station and a user equipment.

FIG. 14 is a flowchart depicting embodiments of a method in a communications system including a host computer, a base station and a user equipment.

FIG. 15 is a flowchart depicting embodiments of a method in a communications system including a host computer, a base station and a user equipment.

FIG. 16 is a flowchart depicting embodiments of a method in a communications system including a host computer, a base station and a user equipment.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein relate to solutions where unlicensed spectrum can support licensed spectrum in delivering URLLC services. Flexible cross carrier scheduling of one transport block may be enabled. The embodiments herein relate to delivering URLLC services using both NR and NR-U. The embodiments herein relate to NR, NR-U, URLLC, UL, CG, CCA, LBT. The embodiments herein relate to LTE, NR etc. The embodiments herein relate to UE, eNB, gNB, a baseband part of the UE etc.

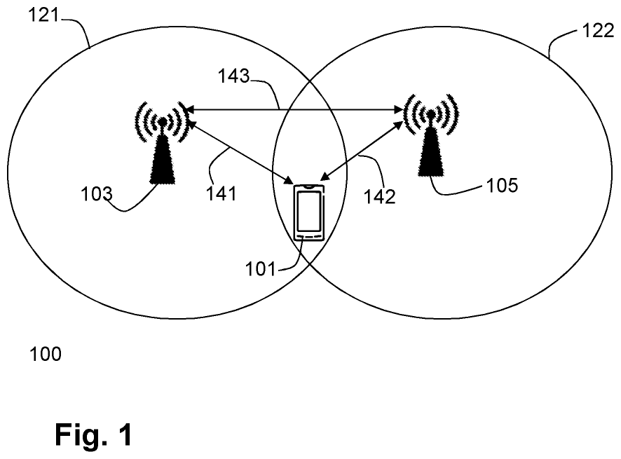

FIG. 1 depicts non-limiting examples of a communications system 100, which may be a wireless communications network, sometimes also referred to as a wireless communications system, cellular radio system, or cellular network, in which embodiments herein may be implemented. The communications system 100 may typically be a 5G system, 5G network, NR-U or Next Gen System or network, LAA, MulteFire, a 4G system, a 3G system, a 2G system, a further generation system or any other suitable system. The communications system 100 may alternatively be a younger system than a 5G system The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify embodiments herein, this should not be seen as limiting the scope of the embodiments herein to only the aforementioned systems. The embodiments herein apply to any previous, current or future system.

The communications system 100 comprises a plurality of network nodes, whereof a first network node 103 and a second network node 105, also referred to herein as a network node 103, 105, are depicted in the non-limiting example of FIG. 1. Any of the first network node 103 and the second network node 105 may be a radio network node, such as a radio base station, or any other network node with similar features capable of serving a user equipment, such as a wireless device or a machine type communication device, in the communications system 100. In some embodiments, the first network node 103 is an eNB and the second network node 105 is a gNB. In other embodiments, the first network node 103 is a first gNB, and the second network node 105 is a second gNB. In yet other embodiments, the first network node 103 may be a MeNB and the second network node 105 may be a gNB. In some examples, any of the first network node 103, and the second network node 105 may be co-localized, or be part of the same network node. In embodiments herein, the first network node 103 may be referred to as a source node or source network node, whereas the second network node 105 may be referred to as a target node or target network node. The first network node may be referred to as a child node and the second network node may be referred to as a parent node.

The communications system 100 covers a geographical area which may be divided into cell areas, wherein each cell area may be served by a network node, although, one network node may serve one or several cells. In the example in FIG. 1, the communications system 100 comprises a first cell and a second cell. In FIG. 1, first network node 103 serves the first cell, and the second network node 105 serves the second cell. Any of the first network node 103, and the second network node 105 may be of different classes, such as, e.g., macro base station (BS), home BS or pico BS, based on transmission power and thereby also cell size. Any of the first network node 103 and the second network node 105 may be directly connected to one or more core networks, which are not depicted in FIG. 1 to simplify the figure. In some examples, any of the first network node 103, and the second network node 105 may be a distributed node, such as a virtual node in the cloud, and it may perform its functions entirely on the cloud, or partially, in collaboration with a radio network node. In embodiments herein, the first cell may be referred to as a source cell, whereas the second cell may be referred to as a target cell.

A plurality UEs may be located in the communication system 100, whereof a UE 101, which may also be referred to simply as a device, is depicted in the non-limiting example of FIG. 1. The UE 101, e.g. a LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some further examples. The UE 101 may be a device by which a subscriber may access services offered by an operator's network and services outside operator's network to which the operator's radio access network and core network provide access, e.g. access to the Internet. The UE 101 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 101 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system.

The first network node 103 may be configured to communicate in the communications system 100 with the UE 101 over a first communication link 141, e.g., a radio link. The second network node 105 may be configured to communicate in the communications system 100 with the UE 101 over a second communication link 142, e.g., a radio link. The first network node 103 may be configured to communicate in the wireless communications network 100 with the second network node 105 over a third communication link 143, e.g., a radio link or a wired link, although communication over more links may be possible.

The UE 101 is enabled to communicate wirelessly within the communications system 100. The communication may be performed e.g. between two devices, between a devices and a regular telephone, between the UE 101 and a network node, between network nodes, and/or between the devices and a server via the radio access network and possibly one or more core networks and possibly the internet.

It should be noted that the communication links in the communications network may be of any suitable kind including either a wired or wireless link. The link may use any suitable protocol depending on type and level of layer (e.g. as indicated by the OSI model) as understood by the person skilled in the art.

### Embodiment 1: Joint Physical Layer Operation Between NR and NR-U

One way of tight cooperation between NR licensed carrier and NR-U is to process data on physical layer jointly. To enable this functionality UE should be instructed to process allocations for different carriers as a one HARQ process. E.g. when UE instructed to receive transport block TB1 on one carrier and TB2 on the other carrier, UE should assume that TB1 and TB2 is the same data. Some physical layer transmission parameters for this case can be derived based on control information for one of the carriers (either NR or NR-U) while other group of parameters can differ. For example:
procedure for transport block determination is done based on one carrier while the same transport block size is assumed for another carrier, hence, TBS determination is done only once.
If transport block size is derived from one carrier parameters, modulation type and channel coding rate can be different for other carrier(s)
Beamforming and power control parameters are carrier specific.

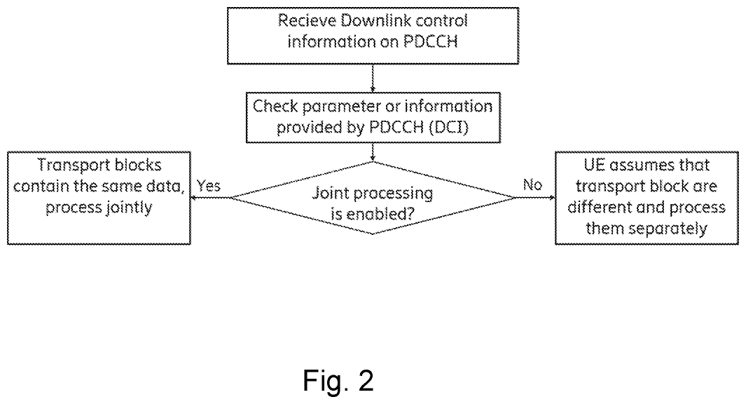

Such functionality can be enabled statically (by RRC configuration when multi-carrier is configured) or UE can be instructed dynamically by PDCCH control channel when this joint TB processing takes place. The algorithm can be illustrated by FIG. 2.

The joint processing here means that UE combine results of data reception from different carriers (NR and NR-U) by any (but not limited to) of the following ways:
received transmissions are combined in a UE soft-buffer;
UE decodes received transmissions jointly by LDPC, Polar or by any other channel coding techniques;
After independent decoding, only correct data (CRC check passed) is accepted.

Different Carrier Allocation to a Single HARQ Process

The transport blocks for a single HARQ process, e.g., TB1 and TB2 can be on different carriers on same spectrum type (NR or NR-U) or different, see Table 1 below.

TABLE 1

| Allocation Type | TB1 carrier over | TB2 carrier over |
|---|---|---|
| 1 | NR | NR-U |
| 2 | NR-U | NR |
| 3 | NR | NR |
| 4 | NR-U | NR-U |

### Embodiment 2: Initial and Re-Transmission in NR(U)

Further considering enhancements, the first network node can dynamically or even statically choose policies where initial and re-transmissions (if needed) can be done in either spectrum band as per their reliability requirement and latency budget. Some of the policies are exemplified in Table 2 below:

TABLE 2

| | Initial transmission | Retransmission | |
|---|---|---|---|
| Policy | (K ≥ 1 repetitions) | (K ≥ 1 repetitions) | Comment |
| 1 | Dynamic allocation in | NR or licensed | |
| | NR or licensed | spectrum | |
| 2 | spectrum | NR-U or unlicensed | |
| | | spectrum | |
| 3 | | Combined NR or | For example, if |
| | | licensed and NR-U or | retransmission is composed |
| | | unlicensed spectrum | of two repetitions, then one |
| | | | repetition occurs in NR |
| | | | spectrum and other in NR-U |
| | | | spectrum |
| 4 | CG allocation in NR or | NR or licensed | |
| | licensed spectrum | spectrum | |
| 5 | | NR-U or unlicensed | |
| | | spectrum | |
| 6 | | Combined NR or | |
| | | licensed and NR-U or | |
| | | unlicensed spectrum | |
| 7 | Dynamic allocation in | NR or licensed | |
| | NR-U or unlicensed | spectrum | |
| 8 | spectrum | NR-U or unlicensed | |
| | | spectrum | |
| 9 | | Combined NR or | |
| | | licensed and NR-U or | |
| | | unlicensed spectrum | |
| 10 | CG allocation in NR-U | NR or licensed | |
| | or unlicensed spectrum | spectrum | |
| 11 | | NR-U or unlicensed | |
| | | spectrum | |
| 12 | | Combined NR or | |
| | | licensed and NR-U or | |
| | | unlicensed spectrum | |
| 13 | Dynamic allocation in | NR or licensed | |
| | combined NR or | spectrum | |
| 14 | licensed and NR-U or | NR-U or unlicensed | |
| | unlicensed spectrum | spectrum | |
| 15 | | Combined NR or | |
| | | licensed and NR-U or | |
| | | unlicensed spectrum | |
| 16 | CG allocation in | NR or licensed | |
| | combined NR or | spectrum | |
| 17 | licensed and NR-U or | NR-U or unlicensed | |
| | unlicensed spectrum, | spectrum | |
| 18 | e.g., see Algorithm 2 in | Combined NR or | |
| | Embodiment 3 | licensed and NR-U or | |
| | | unlicensed spectrum | |

Note, the retransmission is done on dynamic basis (on the fly), i.e., the retransmission resource is allocated if the initial transmission fails.

The criteria for choosing a type of spectrum for initial and retransmission can be based on following:
1. Reliability, e.g., depending on spectrum reliability in either part, initial and re-transmission can be chosen accordingly.
2. Latency, e.g., if latency budget enough to accommodate LBT, then the transmissions can be done in unlicensed spectrum.

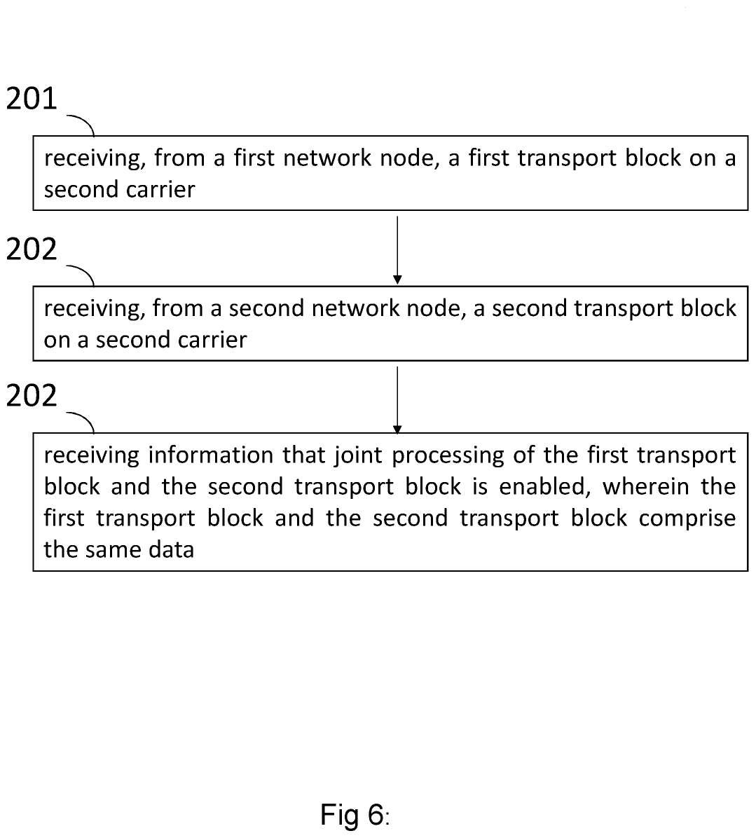

FIG. 6 shows a flowchart depicting a method in a UE, according to embodiments herein. In step 201 the UE receives, from a first network node 103, a first transport block, TB1, on a first carrier. The first carrier may be NR or NR-U carrier. In step 202, the UE receives, from a second network node 105 a second transport block, TB2, on a second carrier. The second carrier may be NR or NR-U carrier. In step 203 the UE receives information that joint processing of the first transport block and the second transport block is enabled, where the first transport block and the second transport block comprise the same data. The UE may receive this information either as a RRC configuration from either the first or the second network node, i.e., a static configuration or as part of the PDCCH, i.e. DCI, in a more dynamic configuration from either the first or the second network node. The HARQ process may be the same for the TB1 received on the first carrier and for TB2 received on the second carrier. One HARQ process is utilized for both TB1 and TB2.

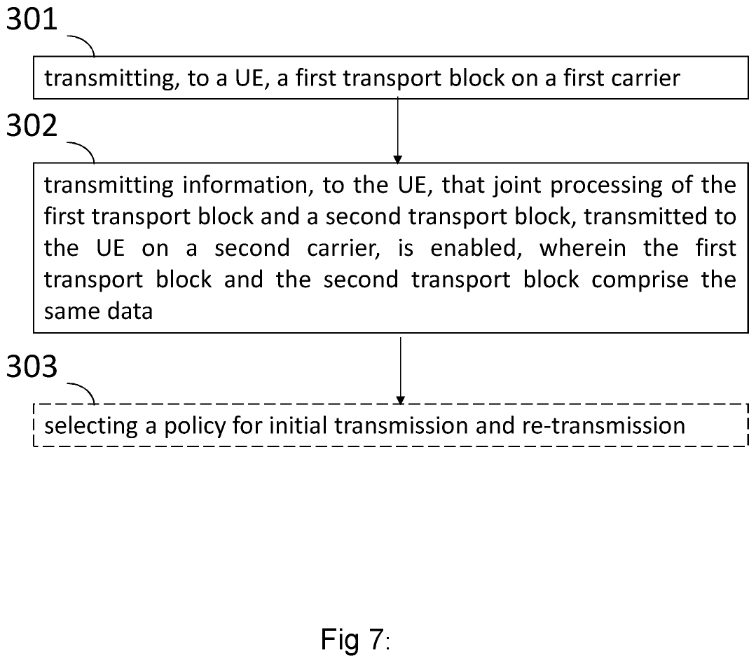

FIG. 7 shows a flowchart depicting a method in a network node 103, according to the embodiments herein. In step 301, the network node transmits to a UE a first transport block, TB1, on a first carrier. The first carrier may be NR or NR-U carrier. In step 302 the network node transmits information, to the UE, that joint processing of the first transport block and a second transport block, transmitted to the UE on a second carrier, is enabled. The network node may transmit this information either as a RRC configuration, i.e., a static configuration or as part of the PDCCH, i.e. DCI, in a more dynamic configuration. The HARQ process may be the same for the TB1 received on the first carrier and for TB2 received on the second carrier. One HARQ process is utilized for both TB1 and TB2. The second carrier may be NR or NR-U carrier used by a second network node 105. The first and second carrier may also be used by the same network node, for example the first network node 103. The first transport block and the second transport block comprise the same data. In step 303, the network node selects a policy for initial transmission and re-transmission. The selection can be static or dynamic. Exemplary policies are shown in Table 2.

### Embodiment 3: Multiplex NR and NR-U Spectrum for UL CG

In unlicensed or NR-U spectrum part, different nodes can co-exist at the same time and transmit altogether. To circumvent this problem, various co-existence strategies, e.g., LBT, CSAT can be implemented. However, it still does not offer the guaranteed reliable usage of the spectrum, and beside latency may increase due to implementation of such techniques. One way to benefit from the use of unlicensed spectrum is by assisting the licensed or NR spectrum part. Two algorithms are provided for the different multiplexing scenario.

### Algorithm 1: Singular CG Resource Period

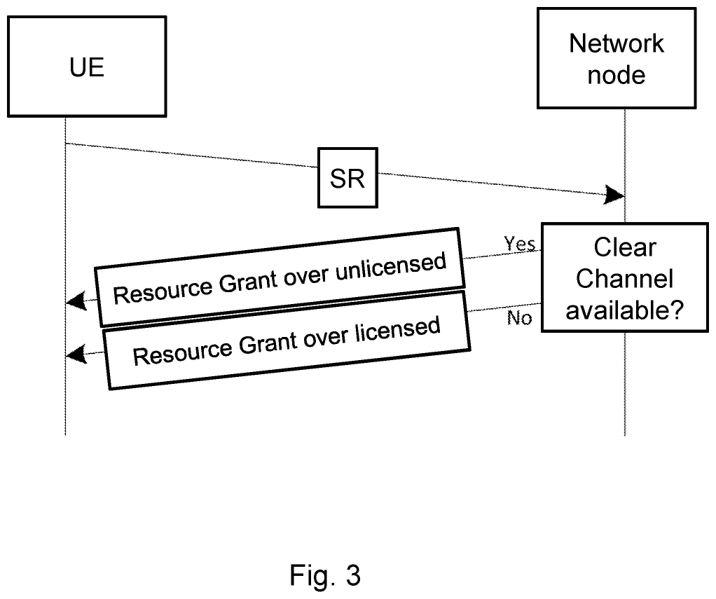

1. The first network node performs channel assessment (e.g., using LBT, CSAT schemes) for unlicensed spectrum,
   a. A clear channel may be described as if the first network node senses no occupation of channel using CCA schemes (in shared or unlicensed channel), the channel is assumed free for a certain period of time,
2. After performing step 1, if clear channel is available in the unlicensed spectrum, first network node allocates the CG resource in the unlicensed spectrum, until the assessment procedure is scheduled, otherwise,
3. If clear channel is not available in the unlicensed spectrum, first network node then allocates CG resource in the licensed spectrum, until the assessment procedure is scheduled.
4. Notes
   a. In step 2, UE may perform CCA schemes like LBT as well before transmission (if commanded by the network or according to the policy),
      i. If the CG period is long, and it may happen in future that channel is not free, then CCA utilization perhaps become important in order to minimize collisions,
      ii. Different methodologies, e.g., mentioned in Embodiment 6 for assessing clear channel can be utilized by the UE,
b. Instead of CG resource in step 2 and 3, it can be a dynamic resource (i.e., SR based). For example, upon receiving SR, the first network node performs CCA, and if successful, it allocates unlicensed spectrum for UL transmission, otherwise (if failed) it allocates licensed spectrum, see FIG. 3.

### Algorithm 2: Hybrid CG Resource Period

In this approach, the TOs belonging to the single CG period is distributed over both licensed and unlicensed spectrum.

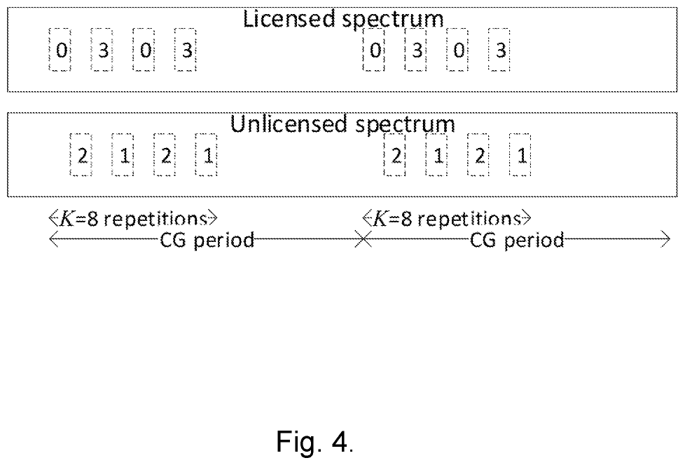

For example, the licensed spectrum can have at least one or all RV 0s (or RV 3 which is also almost self-decodable RV) based TOs amongst from the given RV sequence. This is because, licensed spectrum can be more reliable, and RV 0 (or RV 3) is a fully decodable TO, and in case transmission suffers in the unlicensed part, there is still a viable probability that overall transmission can be decoded due to the transmission of fully decodable RV(s) in the licensed part. See FIG. 4, where some TOs (RV 0 and 3) are allocated in licensed spectrum and other TOs in unlicensed spectrum.

To summarize, in Algorithm 1, at a given time, a CG period is allocated in either licensed part or unlicensed part. Whereas, in Algorithm 2, the TOs of a single CG period are distributed over both licensed and unlicensed spectrum part.

### Embodiment 4: Multiplex NR and NR-U Spectrum for UL Dynamic Allocation for Initial or Re-Transmission

Unlike in Embodiment 3, here, the granted resource can be dynamic allocation instead of a part of CG allocation. This dynamic allocation can be for
1. Initial transmission resource,
2. Re-transmission resource.

### Embodiment 5: Autonomous (NR-U) and SR-Based Grant Multiplexing

A. Request dedicated (licensed) resource in case unlicensed resource unavailable

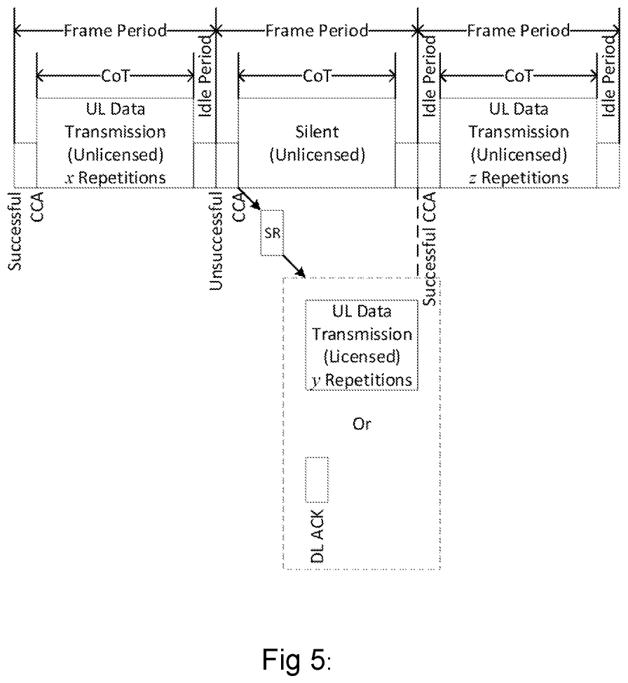

UE senses free channel on NR-U (or unlicensed) spectrum, and performs x repetitions, and if the sensing fails, then UE progresses to SR in licensed spectrum for the transmission of y repetitions. In reply to SR, the first network node can give ACK (if previous repetitions decoded) or allocate new dedicated resource during the time, CoT is unsuccessful in the unlicensed part (due to unsuccessful CCA). In FIG. 5, UE performs x+y+z repetitions, where x+y+z≤K repetitions and K repetitions can be interpreted as K CG repetitions. The repetitions x or z are easy to determine or allocate if it is based on Frame Based Equipment (FBE). On the contrary, determining x based on Load Based Equipment (LBE) is difficult as the LBE period can be random. Here, two classifications can be laid out,
The repetitions during Channel Occupancy Time (CoT) can be part of CG in unlicensed spectrum,
The repetitions during Channel Occupancy Time (CoT) can be part of dynamic allocation
B. Transmit in Unlicensed part in case dynamic resource is delayed or not sent

In this embodiment, UE transmits SR for an UL transmission resource. If the resource is not granted within some time-budget, then UE starts transmitting on unlicensed band, provided the channel is free.

To have free channel, UE must have had successful CCA before the transmission. For this UE should perform LBT (or other CCA schemes) at the same time of SR, or right after transmitting SR, or even at regular intervals.

### Embodiment 6: Sensing Occasions for K Repetitions (CG or Dynamic Scheduling)

Sensing is required in unlicensed spectrum before transmission. Hence, different algorithms in this regard are exemplified.
A. Channel sensing, e.g., LBT type schemes can be performed before every k out
   K repetitions, where k=1, . . . , K.
   If k=1, then sensing is before every repetition.
   If k=K, then sensing is only before first repetition
B. If a period with K TOs is allocated in unlicensed part as a part of CG, then these K TOs are pre-allocated way earlier in time. When actual transmission about to happen on K TOs (in the form of K repetitions), UE can do LBT or channel sensing scheme before every k out K repetitions, where k=1, . . . , K.
   If for some duration, channel sensing is unsuccessful, then those equivalent amounts of repetitions should not be delivered.
C. Channel sensing can be performed after every t time units or symbols or slots.
   If channel is vacant then j number of repetitions can be performed during the time channel is predicted free after successful CCA.

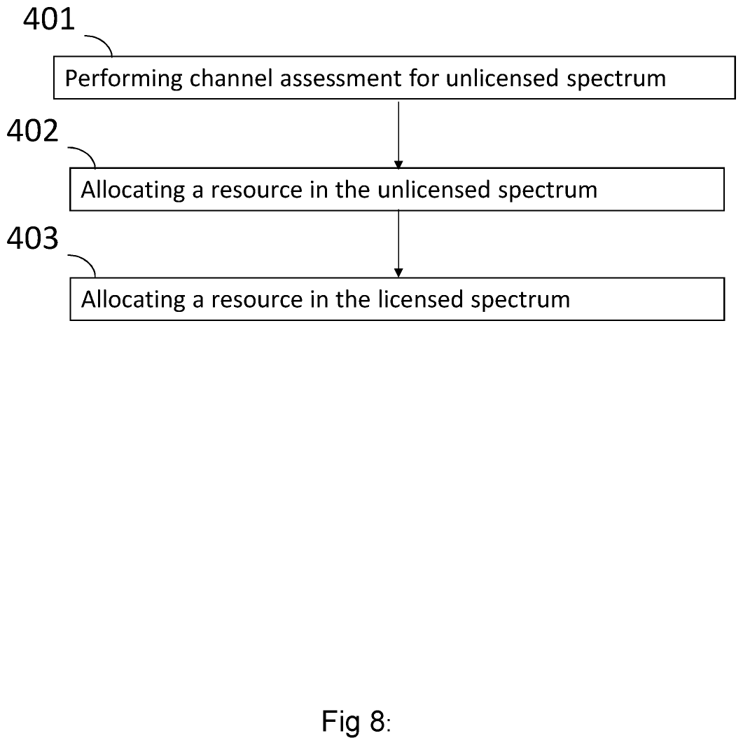

FIG. 8 shows a flowchart depicting a method in a network node 103, 105, according to the embodiments herein. In step 401, the network node performs channel assessment for unlicensed spectrum and if clear channel is available in the unlicensed spectrum, in step 402, the network node allocates a resource in the unlicensed spectrum, until the assessment procedure is scheduled. If clear channel is not available, the network node, in step 403, allocates a resource in the licensed spectrum, until the assessment procedure is scheduled. The channel assessment may be performed using a LBT or a CSAT scheme. The allocation of a resource may include allocating configured grant, CG, resource or a dynamic resource. In some embodiments the channel sensing is performed before every k out K repetitions.

### Embodiment 7: Similar Concept Extension for DL Scheduling

All the above Embodiments 1-6 can be extended for DL dynamic or DL SPS (alternative to CG in DL) allocation.

### Embodiment 8: Shared Spectrum Instead of Unlicensed

The discussion in Embodiment 1-7 can be extended to the spectrum which is a shared spectrum unlike the unlicensed spectrum. The shared spectrum is owned by group of players where each player has an equal right over the shared spectrum. For the shared spectrum, CCA may or may not be implemented.

### Embodiment 9: Offloading Non-Critical Data to Unlicensed Spectrum

In this embodiment, an unlicensed spectrum is used to compliment a licensed spectrum to support multiplexing of multiple UL transmissions with different requirements/QoS (from one UE) by offloading non-critical ones to the unlicensed spectrum.

In some versions of the embodiment, operation in the licensed spectrum is a default mode of operation, where offloading of non-critical traffic is triggered/activated under some conditions.

The conditions for triggering offloading process above can be
when UL transmissions of non-critical and critical data from one UE overlap in time according to their corresponding scheduled/configured resources
when there exist resources in the unlicensed spectrum following some channel access procedures such as LBT.

In such process, a more critical data is prioritized and transmitted over the licensed spectrum, while a less critical data is offloaded to be transmitted in the unlicensed spectrum. To determine which data is more or less critical can be based on priority information associated with the traffic/data such as 5QI, or associated reliability and/or latency requirements.

In one version of the above embodiment, only data with priority level below a certain threshold level is allowed to be offloaded to the unlicensed spectrum.

In one version of the above embodiment, there exists an explicit “offload” signal sent by UE to BS. The offload signal is sent
when there is high priority data in the queue ready to be transmitted while there is ongoing transmission of non-critical traffic, or
when high priority and low priority data to be transmitted are overlapped in time according to their corresponding scheduled/configured resources

Based on the offload signal, the first network node can be prepared to receive an UL transmission in unlicensed spectrum, e.g., by providing an UL grant or configuring resources for UE for UL transmission in the unlicensed spectrum.

An alternative to having an explicit offload signal is that UE directly sends a scheduling request to request or use existing configured resources to transmit non-critical UL data in the unlicensed spectrum.

In some version of above embodiments, the low priority/less critical data offloaded to the unlicensed spectrum may be transmitted at the same time (partially overlapping) or at a later time than data transmitted in the licensed spectrum.

### Embodiment 10: Unlicensed Spectrum Used to Provide Redundant Path for Transmission

Redundant path for transmission can be used to enhance reliability or reduce latency of the transmission. In this embodiment, the unlicensed spectrum is use together with licensed spectrum to provide such redundant path for possible higher reliability and/or lower latency. This can be done by repeating transmission over both licensed and unlicensed spectrum.

Depending on the availability of transmission resources in the licensed and unlicensed spectrum, different receiving alternative can be considered, e.g.,
If both transmissions in licensed and unlicensed spectrum are received within a certain time window (satisfying the latency requirement), coherent combining of the two transmissions is done.
Else, only the first transmission is considered.

Further IIoT and URLLC Enhancements:

5G for Connected Industries

One of the 5G objectives is to enable connected industries:
for digital transformation of industries,
for improved flexibility,
for improved productivity and efficiency,
for improved operational safety.

NR Rel-15 established a solid foundation and Rel-16 introduces further enhancements for better serving various industry verticals:
Many on-going 3GPP WIs in Rel-16, in both SA and RAN
In RAN
   NR V2X (RAN1-led): automotive industry, transport industry
   NR eURLLC (RAN1-led) and NR-IIoT (RAN2-led): factory automation, transport industry, electrical power distribution.

Rel-17 would further strengthen NR for the industry verticals and URLLC use cases.

Rel-17 Further IIoT and URLLC Enhancements

URLLC enhancements
Improve spectral efficiency and capacity for URLLC
Enhancements for wide-area operation
Enhancements for FR2
Keep maximum synergies with NR and carefully justify enhancement features

IIoT and URLLC for unlicensed band operation
Consider both license-assisted access and stand-alone
Keep maximum synergies with Rel-16 NR and NR-U

Enhancement for TSN-5G integration and non-public network (NPN) support.

URLLC Spectral Efficiency and Capacity Enhancement

Motivation:
Requirements on reliability and latency are achieved at the cost of spectral efficiency
Minimizing impact on network capacity is highly desirable
Reduce required bandwidth for operating a stand-alone industrial IoT system
Reduce impact on eMBB capacity when URLLC features are enabled in an MNO network

Rel-17 Scope:
Improve capacity through enhanced multiplexing efficiency and scheduling flexibility (e.g., eMBB/URLLC multiplexing)
Improve spectral efficiency through soft HARQ feedback and enhanced CSI estimation and reporting
Improve spectral efficiency through processing timeline enhancements→allow more HARQ retransmissions within targeted latency
Improved capacity through traffic offloading to unlicensed spectrum.

Unlicensed Spectrum

Motivation:
Unlicensed spectrum can be used for providing URLLC services
In interference-controlled environment
For URLLC services with less stringent requirements
In licensed-assisted scenarios, work jointly with licensed carriers

Rel-17 scope:
Adapt Rel-16 NR-U for URLLC use cases
Dynamic licensed carrier traffic offloading by serving some UEs or LCHs of UE in unlicensed
   Move eMBB to decrease interference
   Move URLLC with relaxed requirements (or with favorable radio conditions) to unlicensed carriers, keep demanding UEs in licensed
PDCP duplication or other reliability enhancements utilizing both licensed and unlicensed carriers.

Cell-Edge and Wide-Area Enhancements

Motivation:
URLLC use cases are not only limited to deployments in factory or industrial campuses

Wide-area URLLC use cases in MNO networks are of significant interests.

Rel-17 scope:
Enhancements for multi-TRP operation
   Multi-TRP scheduling for better handling of, e.g., inter-cell interference
   Improved CSI for better handling, e.g., inter-cell interference, including pre-coded interference.
Improve the performance of cell-edge UEs, including UEs corresponding to lower Q values than what have been considered in Rel-15/16
Improve spectral efficiency and capacity
Enhancements for accurate reference time signaling in RAN for wide-area use cases.

TSN and 5G Integration

Motivation:
Rel-16 IIoT work on TSN and 5G integration is an important step toward supporting high performance Ethernet applications for industrial automation
   Room for further enhancing the support and integration of TSN

Rel-17 scope:
Further enhancements for system capacity while satisfying QoS for TSC traffic patterns
   Efficient multiplexing of single/multiple UEs with multiple TSC traffic patterns, e.g. flexible SPS & configured grant (CG) configurations
      Enhancements for better alignment of TSC traffic pattern and UL CG pattern
Enhancements for accurate reference time signalling in RAN, e.g. downlink propagation delay compensation, in particular for wide-area use cases.

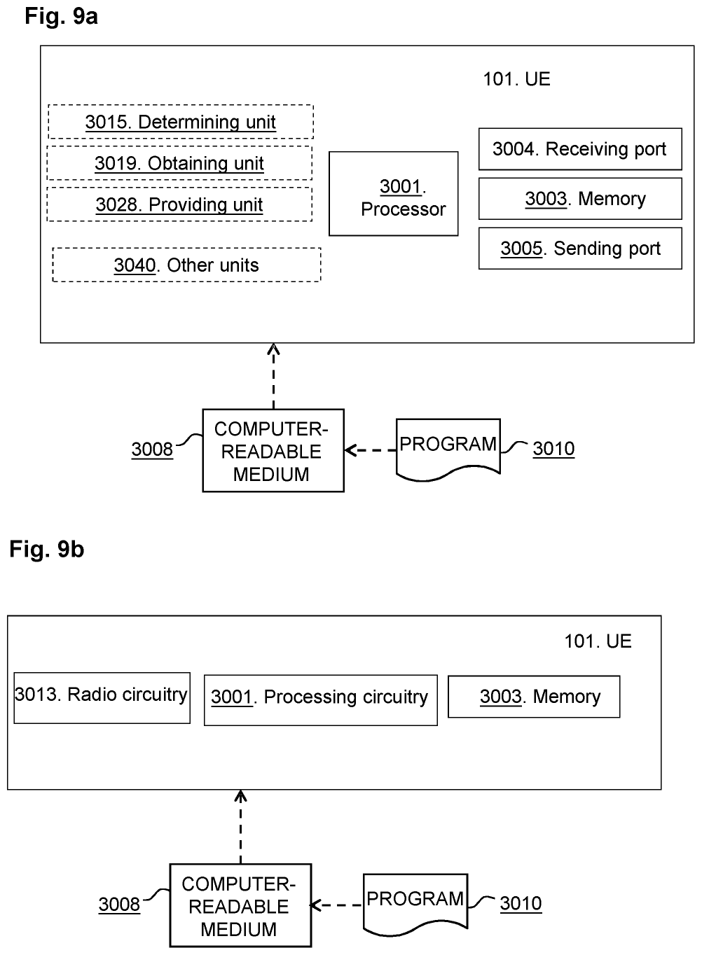

FIG. 9a and FIG. 9b depict two different examples in panels a) and b), respectively, of the arrangement that the UE 101 may comprise. In some embodiments, the UE 101 may comprise the following arrangement depicted in FIG. 9a.

The embodiments herein in the UE 101 may be implemented through one or more processors, such as a processor 3001 in the UE 101 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the UE 101. One such carrier may be in the form of a CD ROM disc. It is however feasible with other data carriers such as a memory stick. The computer program code may furthermore be provided as pure program code on a server and downloaded to the UE 101.

The UE 101 may further comprise a memory 3003 comprising one or more memory units. The memory 3003 is arranged to be used to store obtained information, store data, configurations, schedulings, and applications etc. to perform the methods herein when being executed in the UE 101.

In some embodiments, the UE 101 may receive information from, e.g. the first network node 103 and/or the second network node 105, through a receiving port 3004. In some embodiments, the first receiving port 3004 may be, for example, connected to one or more antennas in UE 101. In other embodiments, the UE 101 may receive information from another structure in the communications system 100 through the first receiving port 3004. Since the first receiving port 3004 may be in communication with the processor 3001, the receiving port 3004 may then send the received information to the processor 501. The receiving port 3004 may also be configured to receive other information.

The processor 501 in the UE 101 may be further configured to transmit or send information to e.g. first network node 103 and/or the second network node 105, or another structure in the communications system 100, through a sending port 3005, which may be in communication with the processor 3001, and the memory 3003.

The UE 101 may comprise a determining unit 3015, an obtaining unit 3018, a providing unit 3028, other units 3040 etc.

Those skilled in the art will also appreciate that the determining unit 3015, obtaining unit 3018, a providing unit 3028, other units 3040 described above may refer to a combination of analog and digital circuits, and/or one or more processors configured with software and/or firmware, e.g., stored in memory, that, when executed by the one or more processors such as the processor 3001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 3015-3040 described above may be implemented as one or more applications running on one or more processors such as the processor 3001.

Thus, the methods according to the embodiments described herein for the UE 101 may be respectively implemented by means of a computer program 3010 product, comprising instructions, i.e., software code portions, which, when executed on at least one processor 3001, cause the at least one processor 3001 to carry out the actions described herein, as performed by the UE 101. The computer program 3010 product may be stored on a computer-readable storage medium 3008. The computer-readable storage medium 3008 having stored thereon the computer program 3010, may comprise instructions which, when executed on at least one processor 3001, cause the at least one processor 3001 to carry out the actions described herein, as performed by the UE 101. In some embodiments, the computer-readable storage medium 3008 may be a non-transitory computer-readable storage medium, such as a CD ROM disc, or a memory stick. In other embodiments, the computer program 3010 product may be stored on a carrier containing the computer program 3010 just described, wherein the carrier is one of an electronic signal, optical signal, radio signal, or the computer-readable storage medium 3008, as described above.

The UE 101 may comprise a communication interface configured to facilitate communications between the UE 101 and other nodes or devices, e.g., the first network node 103 and/or the second network node 105, or another structure. The interface may, for example, include a transceiver configured to transmit and receive radio signals over an air interface in accordance with a suitable standard.

In other embodiments, the UE 101 may comprise the following arrangement depicted in FIG. 9b. The UE 101 may comprise a processing circuitry 3001, e.g., one or more processors such as the processor 3010, in the UE 101 and the memory 3003. The UE 101 may also comprise a radio circuitry 3013, which may comprise e.g., the receiving port 3004 and the sending port 3005. The processing circuitry 3001 may be configured to, or operable to, perform the method actions described herein, in a similar manner as that described in relation to FIG. 9a. The radio circuitry 3013 may be configured to set up and maintain at least a wireless connection with the UE 101. Circuitry may be understood herein as a hardware component.

Hence, embodiments herein also relate to the UE 101 operative to operate in the communications system 100. The UE 101 may comprise the processing circuitry 3011 and the memory 3003, said memory 3003 containing instructions executable by said processing circuitry 3011, whereby the UE 101 is further operative to perform the actions described herein in relation to the UE 101.

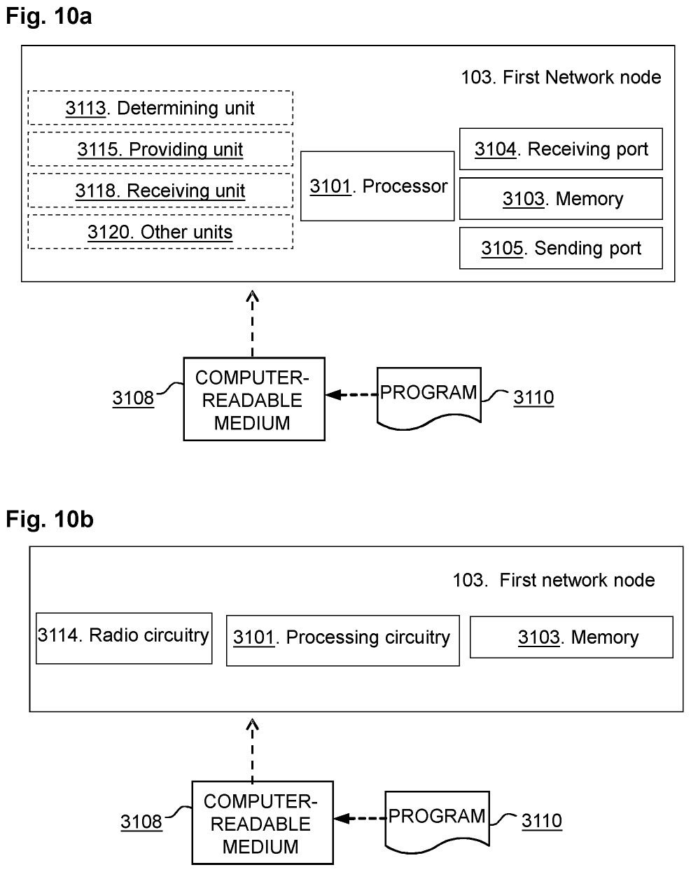

FIGS. 10a and 10b depict two different examples in panels a) and b), respectively, of the arrangement that the network node 103 may comprise. In some embodiments, the network node 105 may comprise the following arrangement depicted in FIG. 10a.

The embodiments herein in the a first network node 103 may be implemented through one or more processors, such as a processor 3101 in the first network node 103 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 103. One such carrier may be in the form of a CD ROM disc. It is however feasible with other data carriers such as a memory stick. The computer program code may furthermore be provided as pure program code on a server and downloaded to the first network node 103.

The first network node 103 may further comprise a memory 3103 comprising one or more memory units. The memory 3103 is arranged to be used to store obtained information, store data, configurations, schedulings, and applications etc. to perform the methods herein when being executed in the first network node 103.

In some embodiments, the first network node 103 may receive information from, e.g., the UE 101 and/or the second network node 105 through a receiving port 3104. In some embodiments, the second receiving port 3104 may be, for example, connected to one or more antennas in first network node 103. In other embodiments, the first network node 103 may receive information from another structure in the communications system 100 through the receiving port 3104. Since the receiving port 3104 may be in communication with the second processor 601, the receiving port 3104 may then send the received information to the processor 3101. The receiving port 3104 may also be configured to receive other information.

The processor 3101 in the first network node 103 may be further configured to transmit or send information to e.g., the UE 101 and/or the second network node 105, or another structure in the communications system 100, through a sending port 3105, which may be in communication with the processor 311, and the memory 3103.

The first network node 103 may comprise a determining unit 3113, a creating unit 3115, a providing unit 3118, other units 3120 etc.

Those skilled in the art will also appreciate that the determining unit 3113, the providing unit 3115, the receiving unit 3118 etc. described above may refer to a combination of analog and digital circuits, and/or one or more processors configured with software and/or firmware, e.g., stored in memory, that, when executed by the one or more processors such as the processor 3101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 3113-3120 described above may be implemented as one or more applications running on one or more processors such as the processor 3101.

Thus, the methods according to the embodiments described herein for the first network node 103 may be respectively implemented by means of a computer program 3110 product, comprising instructions, i.e., software code portions, which, when executed on at least one processor 3101, cause the at least one processor 3101 to carry out the actions described herein, as performed by the first network node 103. The computer program 3110 product may be stored on a computer-readable storage medium 3108. The computer-readable storage medium 3108, having stored thereon the computer program 3110, may comprise instructions which, when executed on at least one processor 3101, cause the at least one processor 3101 to carry out the actions described herein, as performed by the first network node 103. In some embodiments, the computer-readable storage medium 3110 may be a non-transitory computer-readable storage medium, such as a CD ROM disc, or a memory stick. In other embodiments, the computer program 3110 product may be stored on a carrier containing the computer program 3110 just described, wherein the carrier is one of an electronic signal, optical signal, radio signal, or the computer-readable storage medium 3108, as described above.

The first network node 103 may comprise a communication interface configured to facilitate communications between the first network node 103 and other nodes or devices, e.g., the UE 101 and/or the second network node 105, or another structure. The interface may, for example, include a transceiver configured to transmit and receive radio signals over an air interface in accordance with a suitable standard.

In other embodiments, the first network node 103 may comprise the following arrangement depicted in FIG. 10b. The first network node 103 may comprise a processing circuitry 3111, e.g., one or more processors such as the processor 3101, in the first network node 103 and the memory 3103. The first network node 103 may also comprise a radio circuitry 3113, which may comprise e.g., the receiving port 3104 and the sending port 3105. The processing circuitry 3111 may be configured to, or operable to, perform the method actions described herein in a similar manner as that described in relation to FIG. 10a. The radio circuitry 3113 may be configured to set up and maintain at least a wireless connection with the first network node 103. Circuitry may be understood herein as a hardware component.

Hence, embodiments herein also relate to the first network node 103 operative to operate in the communications system 100. The first network node 103 may comprise the processing circuitry 3113 and the memory 3103, said memory 3103 containing instructions executable by said processing circuitry 3113, whereby the first network node 103 is further operative to perform the actions described herein in relation to the first network node 105.

### FURTHER EXTENSIONS AND VARIATIONS

Telecommunication network connected via an intermediate network to a host computer in accordance with some embodiments.

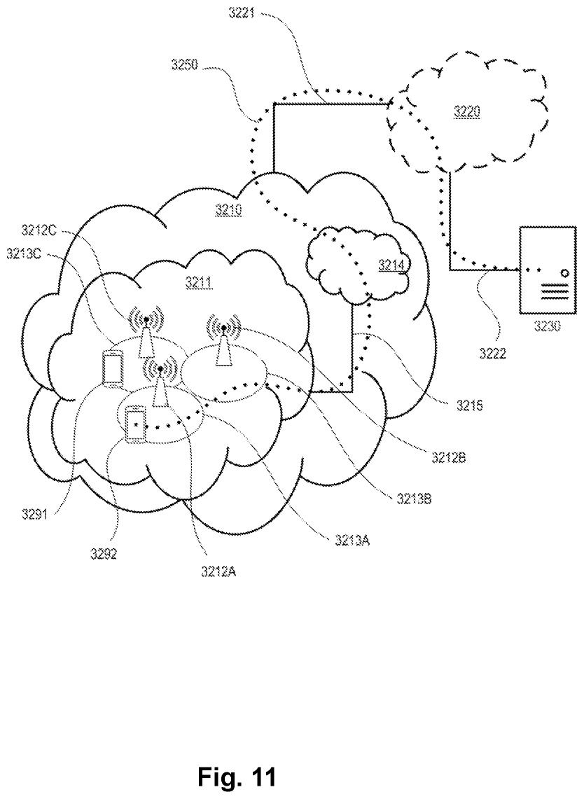

With reference to FIG. 11, in accordance with an embodiment, a communication system includes telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 101 may be comprised in the communications system 100. In FIG. 11, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212. Any of the UEs 3291, 3292 may be considered examples of the UE 101.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 11 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

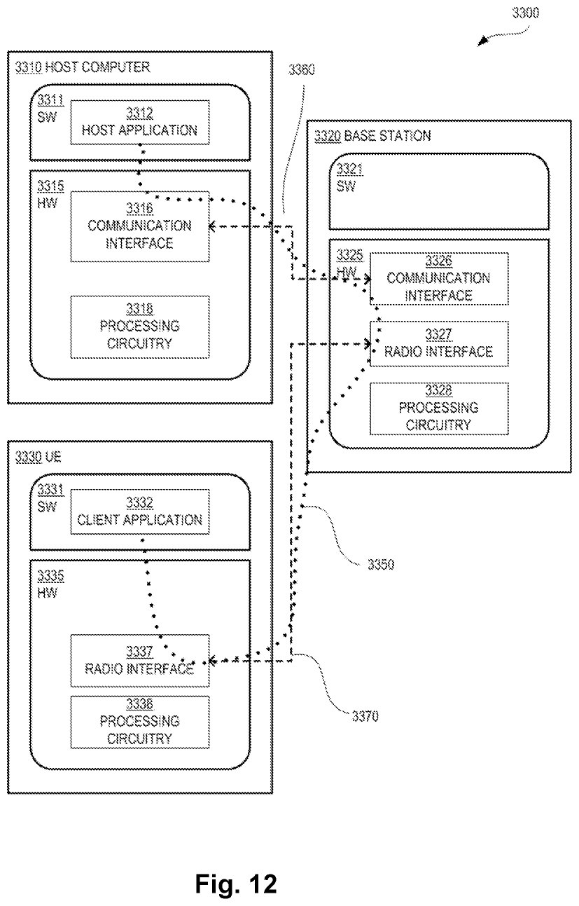

In relation to FIGS. 12-16 which are described next, it may be understood that the base station may be considered an example of the first network node 103.

FIG. 12 illustrates an example of host computer communicating via a first network node 103 with a UE 101 over a partially wireless connection in accordance with some embodiments

The UE 101 and the first network node 103, e.g., a base station and host computer discussed in the preceding paragraphs will now be described with reference to FIG. 12. In communication system 333, such as the communications system 100, host computer 3310 comprises hardware 3315 including communication interface 3316 configured to set up and maintain a wired or wireless connection with an interface of a different communication device of communication system 33. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 335 terminating at UE 3330 and host computer 3310. In providing the service to the remote user, host application 3312 may provide user data which is transmitted using OTT connection 335.

Communication system 33 further includes the first network node 103 exemplified in FIG. 12 as a base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 33, as well as radio interface 3327 for setting up and maintaining at least wireless connection 337 with the UE 101, exemplified in FIG. 12 as a UE 3330 located in a coverage area served by base station 3320. Communication interface 3326 may be configured to facilitate connection 336 to host computer 3310. Connection 336 may be direct or it may pass through a core network (not shown in FIG. 12) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 33 further includes UE 3330 already referred to. It's hardware 3335 may include radio interface 3337 configured to set up and maintain wireless connection 337 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 335 terminating at UE 3330 and host computer 3310. In providing the service to the user, client application 3332 may receive request data from host application 3312 and provide user data in response to the request data. OTT connection 335 may transfer both the request data and the user data. Client application 3332 may interact with the user to generate the user data that it provides.

It is noted that host computer 3310, base station 3320 and UE 3330 illustrated in FIG. 12 may be similar or identical to host computer 3230, one of base stations 3212a, 3212b, 3212c and one of UEs 3291, 3292 of FIG. 11, respectively. This is to say, the inner workings of these entities may be as shown in FIG. 12 and independently, the surrounding network topology may be that of FIG. 11.

In FIG. 12, OTT connection 335 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 335 is active, the network infrastructure may further take decisions by which it dynamically changes the routing (e.g., on the basis of load balancing consideration or reconfiguration of the network).

Wireless connection 337 between UE 3330 and base station 3320 is in accordance with the teachings of the embodiments described throughout this disclosure. One or more of the various embodiments improve the performance of OTT services provided to UE 3330 using OTT connection 335, in which wireless connection 337 forms the last segment. More precisely, the teachings of these embodiments may improve the spectrum efficiency, and latency, and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 335 between host computer 3310 and UE 3330, in response to variations in the measurement results. The measurement procedure and/or the network functionality for reconfiguring OTT connection 335 may be implemented in software 3311 and hardware 3315 of host computer 3310 or in software 3331 and hardware 3335 of UE 3330, or both. In embodiments, sensors (not shown) may be deployed in or in association with communication devices through which OTT connection 335 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 335 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 335 while it monitors propagation times, errors etc.

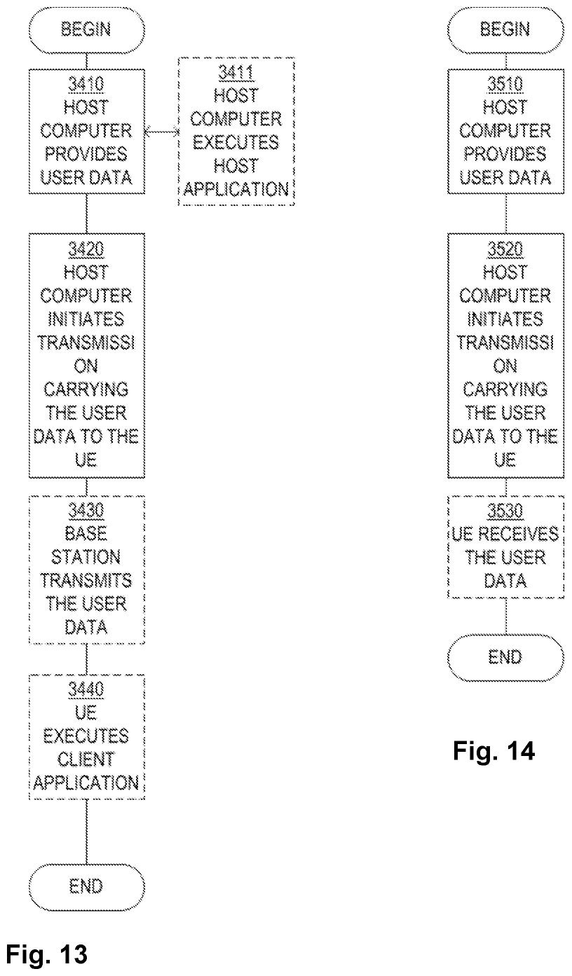

FIG. 13 illustrates an example of methods implemented in a communication system including a host computer, a base station and a user equipment. FIG. 13 is a flowchart illustrating a method implemented in a communication system. The communication system includes a host computer, a base station and a UE which may be those described with reference to FIG. 11 and FIG. 12. For simplicity of the present disclosure, only drawing references to FIG. 13 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 14 illustrates methods implemented in a communication system including a host computer, a base station and a user equipment in accordance with some embodiments. FIG. 14 is a flowchart illustrating a method implemented in a communication system. The communication system includes a host computer, a base station and a UE which may be those described with reference to FIG. 11 and FIG. 12. For simplicity of the present disclosure, only drawing references to FIG. 14 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

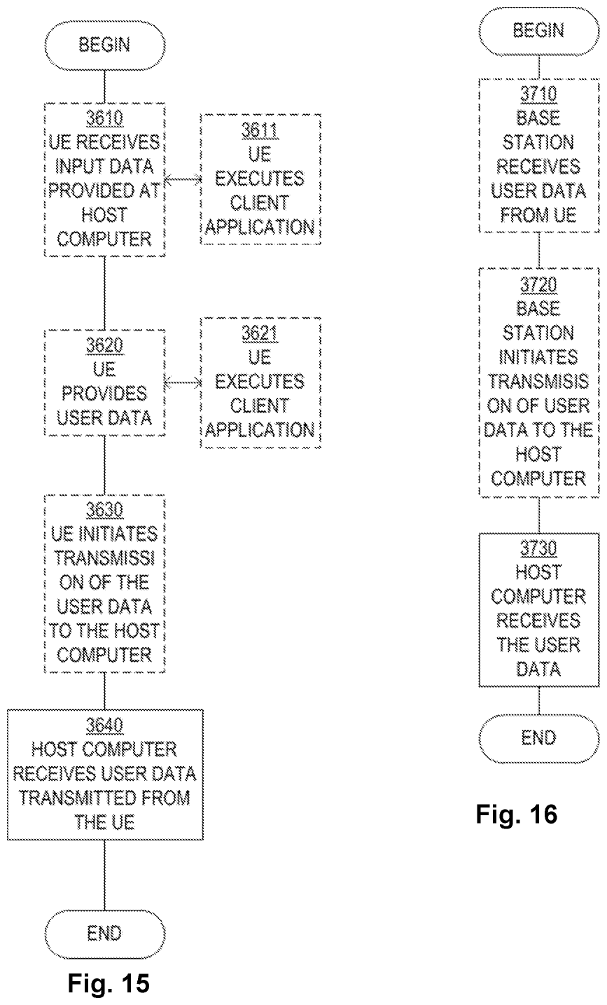

FIG. 15 illustrates methods implemented in a communication system including a host computer, a base station and a user equipment. FIG. 15 is a flowchart illustrating a method implemented in a communication system. The communication system includes a host computer, a first network node 103 and a UE 101 which may be those described with reference to FIG. 11 and FIG. 12. For simplicity of the present disclosure, only drawing references to FIG. 15 will be included in this section. In step 3610 (which may be optional), the UE 101 receives input data provided by the host computer. Additionally or alternatively, in step 3620, the UE 101 provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 16 illustrates methods implemented in a communication system including a host computer, a base station and a user equipment. FIG. 16 is a flowchart illustrating a method implemented in a communication system. The communication system includes a host computer, a base station and a UE which may be those described with reference to FIG. 11 and FIG. 12. For simplicity of the present disclosure, only drawing references to FIG. 16 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Some embodiments may be summarized as follows:

A base station configured to communicate with a UE 101, the base station comprising a radio interface and processing circuitry configured to perform one or more of the actions described herein as performed by the first network node 103.

A communication system 100 including a host computer comprising:
processing circuitry configured to provide user data; and
a communication interface configured to forward the user data to a cellular network for transmission to a UE 101,
wherein the cellular network comprises a first network node 103 having a radio interface and processing circuitry, the base station's processing circuitry configured to perform one or more of the actions described herein as performed by the network node 103.

The communication system may further including the first network node 103.

The communication system may further include the UE 101, wherein the UE 101 is configured to communicate with the first network node 103.

The communication system, wherein:
the processing circuitry of the host computer is configured to execute a host application, thereby providing the user data; and
the UE 101 comprises processing circuitry configured to execute a client application associated with the host application.

A method implemented in a first network node 103, comprising one or more of the actions described herein as performed by the first network node 103.

A method implemented in a communication system 100 including a host computer, a base station and a UE 101, the method comprising:
at the host computer, providing user data; and
at the host computer, initiating a transmission carrying the user data to the UE 101 via a cellular network comprising the first network node 103, wherein the first network node 103 performs one or more of the actions described herein as performed by the first network node 103.

The method may further comprise:
at the first network node 103, transmitting the user data.

The user data may be provided at the host computer by executing a host application, and the method may further comprise:
at the UE 101, executing a client application associated with the host application.

A UE 101 configured to communicate with a first network node 103, the UE 101 comprising a radio interface and processing circuitry configured to perform one or more of the actions described herein as performed by the UE 101.

A communication system 100 including a host computer comprising:
processing circuitry configured to provide user data; and
a communication interface configured to forward user data to a cellular network for transmission to a UE 101,
wherein the UE comprises a radio interface and processing circuitry, the UE's processing circuitry configured to perform one or more of the actions described herein as performed by the UE 101.

The communication system may further including the UE 101.

The communication system 100, wherein the cellular network further includes a first network node 103 configured to communicate with the UE 101.

The communication system 100, wherein:
the processing circuitry of the host computer is configured to execute a host application, thereby providing the user data; and
the UE's processing circuitry is configured to execute a client application associated with the host application.

A method implemented in a UE 101, comprising one or more of the actions described herein as performed by the UE 101.

A method implemented in a communication system 100 including a host computer, a first network node 103 and a UE 101, the method comprising:
at the host computer, providing user data; and
at the host computer, initiating a transmission carrying the user data to the UE 101 via a cellular network comprising the base station, wherein the UE 101 performs one or more of the actions described herein as performed by the UE 101.

The method may further comprise:
at the UE 101, receiving the user data from the first network node 103.

A UE 101 configured to communicate with a first network node 103, the UE 101 comprising a radio interface and processing circuitry configured to perform one or more of the actions described herein as performed by the UE 101.

A communication system 100 including a host computer comprising:
a communication interface configured to receive user data originating from a transmission from a UE 101 to a first network node 103,
wherein the UE 101 comprises a radio interface and processing circuitry, the UE's processing circuitry configured to: perform one or more of the actions described herein as performed by the UE 101.

The communication system 100 may further include the UE 101.

The communication system 100 may further include the first network node 103, wherein the first network node 103 comprises a radio interface configured to communicate with the UE 101 and a communication interface configured to forward to the host computer the user data carried by a transmission from the UE 101 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 101, comprising one or more of the actions described herein as performed by the UE 101.

The method may further comprise:
providing user data; and
forwarding the user data to a host computer via the transmission to the first network node 103.

A method implemented in a communication system 100 including a host computer, a first network node 103 and a UE 101, the method comprising:
at the host computer, receiving user data transmitted to the first network node 103 from the UE 101, wherein the UE 101 performs one or more of the actions described herein as performed by the UE 101.

The method may further comprise:
at the UE 101, providing the user data to the first network node 103.

The method may further comprise:
at the UE 101, executing a client application, thereby providing the user data to be transmitted; and
at the host computer, executing a host application associated with the client application.

The method may further comprise:
at the UE 101, executing a client application; and
at the UE 101, receiving input data to the client application, the input data being provided at the host computer by executing a host application associated with the client application,
wherein the user data to be transmitted is provided by the client application in response to the input data.

A first network node 103 configured to communicate with a UE 101, the first network node 103 comprising a radio interface and processing circuitry configured to perform one or more of the actions described herein as performed by the network node 103.

A communication system 100 including a host computer comprising a communication interface configured to receive user data originating from a transmission from a UE 101 to a base station, wherein the first network node 103 comprises a radio interface and processing circuitry, the base station's processing circuitry configured to perform one or more of the actions described herein as performed by the first network node 103.

The communication system 100 may further include the first network node 103.

The communication system 100 may further include the UE 101, wherein the UE 101 is configured to communicate with the first network node 103.

The communication system 100 wherein:
the processing circuitry of the host computer is configured to execute a host application;
the UE 101 is configured to execute a client application associated with the host application, thereby providing the user data to be received by the host computer.

A method implemented in a first network node 103, comprising one or more of the actions described herein as performed by any of the first network node 103.

A method implemented in a communication system including a host computer, a first network node 103 and a UE 101, the method comprising:
at the host computer, receiving, from the first network node 103, user data originating from a transmission which the base station has received from the UE 101, wherein the UE 101 performs one or more of the actions described herein as performed by the UE 101.

The method may further comprise:
at the first network node 103, receiving the user data from the UE 101.

The method may further comprise:
at the first network node 103, initiating a transmission of the received user data to the host computer.

Some embodiments may be summarized as follows:

A method performed by a UE (101), the method comprising at least one of:
receiving DL control information on PDCCH e.g. from the first network node (103);
checking a parameter or information provided by the PDCCH;
determining if joint processing is enabled or disabled;
if joint processing is enabled, determine that transport block comprises the same data, and process jointly; and
if joint processing is disabled, assume that transport blocks are different and process them separately.

Joint processing comprises combining results of data reception from different carriers, e.g. NR and NR-U.

A method performed by the first network node (103), the method comprising at least one of:
transmitting DL control information on PDCCH e.g. to the UE (101).
select, dynamically or statically, policies where initial and re-transmissions can be done in either spectrum band as per their reliability requirement and latency budget

A method performed by a first network node (103), the method comprising at least one of:
performing channel assessment (e.g., using LBT, CSAT schemes) for unlicensed spectrum
if clear channel is available in the unlicensed spectrum, allocating the CG resource in the unlicensed spectrum, until the assessment procedure is scheduled,
If clear channel is not available in the unlicensed spectrum, allocating CG resource in the licensed spectrum, until the assessment procedure is scheduled.
Instead of CG resource, it can be a dynamic resource (i.e., SR based). For example, upon receiving SR, the first network node performs CCA, and if successful, the first network node ma allocate unlicensed spectrum for UL transmission, otherwise (if failed) it allocates licensed spectrum, see FIG. 3.

A method performed by a UE (101), the method comprising at least one of:
performing CCA schemes like LBT as well before transmission (if commanded by the first network node or according to the policy),
assessing clear channel,
etc.

At a given time, a CG period may be allocated in either licensed part or unlicensed part.

The TOs of a single CG period may be distributed over both licensed and unlicensed spectrum part.

The granted resource may be dynamic allocation instead of a part of CG allocation

Dedicated (licensed) resource may be requested in case unlicensed resource unavailable

Transmitting in Unlicensed part in case dynamic resource is delayed or not sent

Channel sensing, e.g., LBT type schemes may be performed before every k out K repetitions.

If a period with K TOs is allocated in unlicensed part as a part of CG, then these K TOs may be pre-allocated way earlier in time.

Channel sensing may be performed after every t time units or symbols or slots.

The embodiments herein may be applied to DL dynamic or DL SPS (alternative to CG in DL) allocation.

The embodiments herein may be applied to the spectrum which is a shared spectrum unlike the unlicensed spectrum.

Non-critical data may be offloaded to unlicensed spectrum.

Unlicensed spectrum may be to provide redundant path for transmission

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description. In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments

The embodiments herein are not limited to the above described embodiments. Various alternatives, modifications and equivalents may be used. Therefore, the above embodiments should not be taken as limiting the scope of the embodiments. A feature from one embodiment may be combined with one or more features of any other embodiment.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods may, without departing from the embodiments herein, be performed in another order than the order in which they appear herein.

### ABBREVIATIONS

### 3GPP 3^{rd} Generation Partnership Project

### 5G 5^{th} Generation

### 5QI 5G QoS Indicator

### ACK Acknowledgement

### BS Base Station

### CCA Clear Channel Assessment

### CG Configured Grant

### CoT Channel Occupancy Time

### CSAT Carrier Sense Adaptive Transmission

### DCI Downlink Control Information

### DL Downlink

### FBE Frame Based Equipment

### gNB Next Generation NodeB

### LTE Long-Term Evolution

### LBE Load Based Equipment

### LBT Listen Before Talk

### NACK No Acknowledgement

### NR New Radio

### NR-U NR-based Access to Unlicensed Spectrum

### PUSCH Physical Uplink Shared Channel

### QoS Quality of Service

### RV Redundancy Version

### SPS Semi-Persistent Scheduling

### SR Scheduling Request

### TTI Transmission Time Interval

### TO Transmission Opportunity

### UE User Equipment

### UL Uplink

### URLLC Ultra-Reliable and Low-Latency Communications

1-27. (canceled)

28. A method performed by a user equipment, UE, in Ultra-Reliable and Low-Latency Communications, URLLC, the method comprising:
receiving, from a first network node, a first transport block on a first carrier;
receiving, from a second network node, a second transport block on a second carrier; and
receiving information that joint processing of the first transport block and the second transport block is enabled, wherein the first transport block and the second transport block comprise the same data.

29. The method of claim 28, wherein the first carrier is one of: a new radio, NR, licensed carrier or unlicensed, U, NR-U carrier, and wherein the second carrier is one of: a NR licensed carrier or unlicensed NR-U carrier.

30. The method of claim 28, wherein the first network node and the second network node are part of the same network node.

31. The method of claim 28, wherein the same HARQ process is used for first transport block and the second transport block.

32. The method of claim 28, wherein the information that joint processing is enabled is received in a Radio Resource Control, RRC, message or in a downlink control information, DCI, from the first network node or from the second network node.

33. A method performed by a network node in Ultra-Reliable and Low-Latency Communications, URLLC, the method comprising:
transmitting, to a user equipment, UE, a first transport block on a first carrier; and
transmitting information, to the UE, that joint processing of the first transport block and a second transport block, transmitted to the UE on a second carrier, is enabled, wherein the first transport block and the second transport block comprise the same data.

34. The method of claim 33, wherein the first carrier is one of: a NR licensed carrier or NR-U unlicensed carrier, and wherein the second carrier is one of: a NR licensed carrier or NR-U unlicensed carrier.

35. The method of claim 33, wherein second transport block is transmitted from the network node.

36. The method of claim 33, wherein the same HARQ process is used for first transport block and the second transport block.

37. The method of claim 33, wherein the information that joint processing is enabled is transmitted in a Radio Resource Control, RRC, message or in a downlink control information, DCI, to the UE.

38. The method according to claim 33, wherein the method further comprises:
selecting a policy for initial transmission and re-transmission.

39. The method of claim 38, wherein the selection of the policy is dynamic or static.

40. The method of claim 39, wherein the selection of the policy is based on spectrum reliability and/or latency budget.

41. A method performed by a network, the method comprising:
performing channel assessment for an unlicensed spectrum; and if clear channel is available in the unlicensed spectrum,
allocating a resource in the unlicensed spectrum, until the assessment procedure is scheduled; else,
allocating a resource in the licensed spectrum, until the assessment procedure is scheduled.

42. The method of claim 41, wherein allocating a resource comprises allocating a configured grant, CG, resource or a dynamic resource.

43. The method of claim 41, wherein the channel assessment is performed using a LBT or CSAT scheme.

44. The method of claim 41, wherein channel sensing is performed before every k out K repetitions.

45. The method of claim 41, wherein the method is performed in Ultra-Reliable and Low-Latency Communications, URLLC.

46. The method of claim 28, wherein joint processing comprises combining results of data reception from the first and second transport blocks.
